(19) United States
(12) Patent Application Publication
(10) Pub. No.: US 2013/0009980 A1
(43) Pub. Date: Jan. 10, 2013

(54) VIEWING-FOCUS ORIENTED IMAGE PROCESSING

(75) Inventor: Hao Ran Gu, Scarborough (CA)

(73) Assignee: ATI TECHNOLOGIES ULC, Markham (CA)

(21) Appl. No.: 13/178,127

(22) Filed: Jul. 7, 2011

(51) Int. Cl. G09G 5/00; G06T 5/00; G09G 5/02

(52) U.S. Cl. 345/611; 345/643; 345/589

(57) ABSTRACT

A method and a processor for implementing the method are disclosed for processing of an image. A first algorithm is selected to be used for processing information representing an area of interest in the image. A second algorithm is selected to be used for processing information representing an area of the image that is not in the area of interest. The first and second algorithms are applied to their respective portions of the information representing the image.

### FIELD OF INVENTION

This disclosure relates to electronic image processing.

### BACKGROUND

Electronic processing of images, both still images and moving images such as video, typically require relatively high processing speeds and large amounts of other processing resources, such as memory. Generally, the higher the image quality desired, the greater the speed required and the larger the amount of resources required. With constantly increasing image resolution, such as HD video, and innovations such as three-dimensional video, greater demands are being placed on image processing hardware and software. Hardware, software or combinations thereof are sought for meeting these demands without noticeable reduction in image quality.

### SUMMARY OF EMBODIMENTS

A method and a processor for implementing the method are disclosed for processing of an image. A first algorithm is selected to be used for processing information representing an area of interest in the image. A second algorithm is selected to be used for processing information representing an area of the image that is not in the area of interest. The first and second algorithms are applied to their respective portions of the information representing the image.

### BRIEF DESCRIPTION OF THE DRAWINGS

FIG. 1 shows system including a processor for implementing a method of image processing.

FIG. 2 is an alternative system for implementing a method of image processing.

FIG. 3 is a flow diagram of a method for image processing.

### DETAILED DESCRIPTION OF EMBODIMENTS

Tradeoffs between image quality and speed or computation resource requirements in image processing may be used to optimize image processing. Various areas of an image may be processed using different image processing algorithms, each algorithm having a different tradeoff.

As an example, it has been found that people viewing a still image or a moving image tend to pay relatively more attention to certain portions of the image and less attention to other portions. A portion of an image attracting relatively more attention from the viewer may be called an “area of interest.” It has been found, for example, that people tend to focus more attention on a moving object than on stationary objects in an image. People also tend to focus more attention on the center of an image than on areas away from the center.

Image processing that produces higher image quality but requires relatively more processing resources may be applied only to the area of interest. Areas of the image outside the area of interest may be processed by algorithms producing lower image quality but requiring fewer resources. This may be called location-dependent image processing or location-optimized image processing. The advantage may be faster processing of entire images with fewer resources but without a noticeable (perceived) loss of quality, as compared to using a single algorithm to process an entire image.

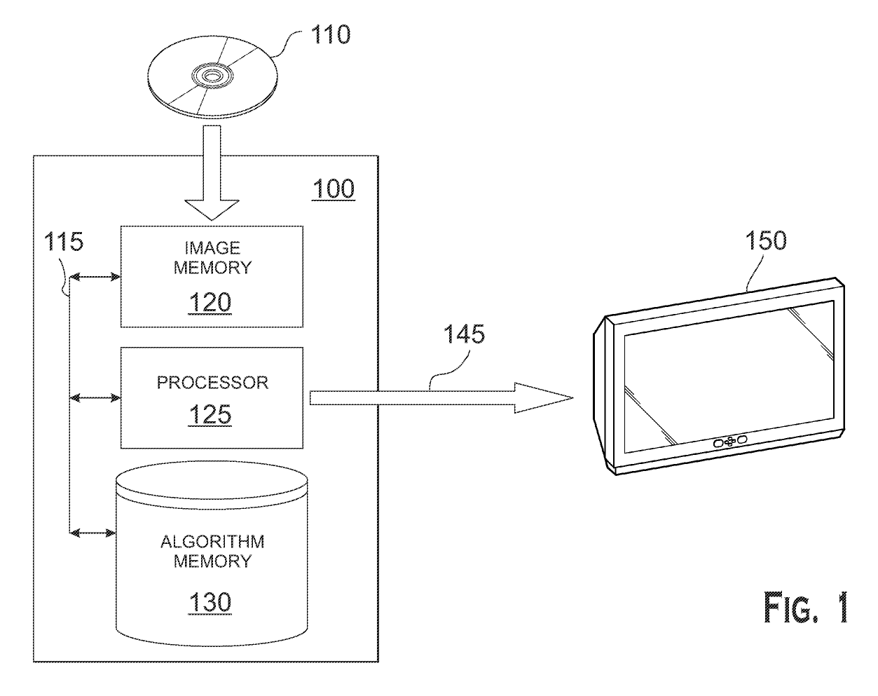

FIG. 1 illustrates one embodiment, not to be construed as limiting, of a system 100 for displaying an image using location-dependent image processing. System 100 includes a processor 125, configured to process information (data) representing an image. A display device 150 is configured to receive the processed information from the processor and display the image. The image may be a still image or a frame of a moving image such as a video image. System 100 may also include an image memory 120 that receives and stores information representing an image, and an algorithm memory 130 that stores a plurality of executable image processing algorithms. Processor 125 may retrieve stored image processing algorithms from algorithm memory 130. Processor 125, image memory 120, and algorithm memory 130 may be interconnected using a system bus 115. The specific implementation of bus 115 is not central to the present description. A cable 145 may connect processor 125 to display device 150, acting as a conduit for information to be displayed as an image on display device 150.

System 100 is configured to receive and process information representing an image or a series of images stored in a medium 110. The information may be digital. The information may represent a single still image, or a frame of a moving image. Medium 110 is depicted as a disc in FIG. 1 but is not limited to that form. Medium 110 may be a non-transitory storage medium such as a DVD, CD, tape, or semiconductor memory. Alternatively, medium 110 may be a transitory medium such as an electromagnetic carrier wave transmitted over the air or through a coaxial cable or optical fiber.

Received information representing the image may be stored in image memory 120. Image memory 120 may store an entire still image, an entire frame of a moving image or more than one frame of a moving image. Image memory 120 may then release the stored image, frame, or frames to processor 125 for processing when commanded by processor 125. Alternatively, only a portion of an image may be stored in image memory 120 at any time. Alternatively, image memory 120 may be absent, and information may be received and processed by processor 125 as it is received, without storage.

Processor 125 may be configured to process received information representing an image based on a method described in greater detail below, employing location dependent image processing, as described above. Processor 125 may determine the area of interest in the image based on instructions in an algorithm. The algorithm may be retrieved from a memory such as a non-volatile memory 130. In addition to using information contained in the image information itself, processor 125 may use other information, such as eye movements of a viewer, to determine the area of interest, as described below.

Once the area of interest is determined, processor 125 may then select and load image processing algorithms. Processor 130 may select a first algorithm to be used for processing a portion of the image information representing the area of interest, and a second algorithm to be used for processing a portion of the image information representing an image area not in the area of interest. This latter area may be, but is not limited to being, the entire image area not included in the area of interest. The area not included in the area of interest may be divided into a plurality of areas, and separate algorithms may be applied to each of these areas. Alternatively, a single, second algorithm, different from the first algorithm, may be applied to the entirety of the image area not included in the area of interest. Processor 125 applies the first and second algorithms to their respective portions of the information representing the image. Once the image processing is completed, the processed information may be sent over cable 145 to display device 150 and rendered as a visible image to a viewer. Alternatively, the processed information may be transmitted wirelessly to display device 150, in which case cable 145 is absent. In an embodiment, the first and second algorithms preserve an aspect ratio of the displayed image. Aspect ratio may be defined as a ratio of a horizontal dimension to a vertical dimension of a two-dimensional displayed image. As an example of aspect ratio, the ratio of horizontal dimension to vertical dimension in a standard High Definition Television (HDTV) image, conventionally oriented, is 16:9. Preserving aspect ratio means that the displayed image is not distorted by the application of the first and second algorithms.

Processor 125 may be configured to determine the area of interest by selecting a predetermined portion of the information representing the image, such as a portion representing the center of the image. Alternatively, processor 125 may compare information representing several consecutive frames of a moving image and determine a portion of the image that includes a moving object. That portion is then selected as the area of interest.

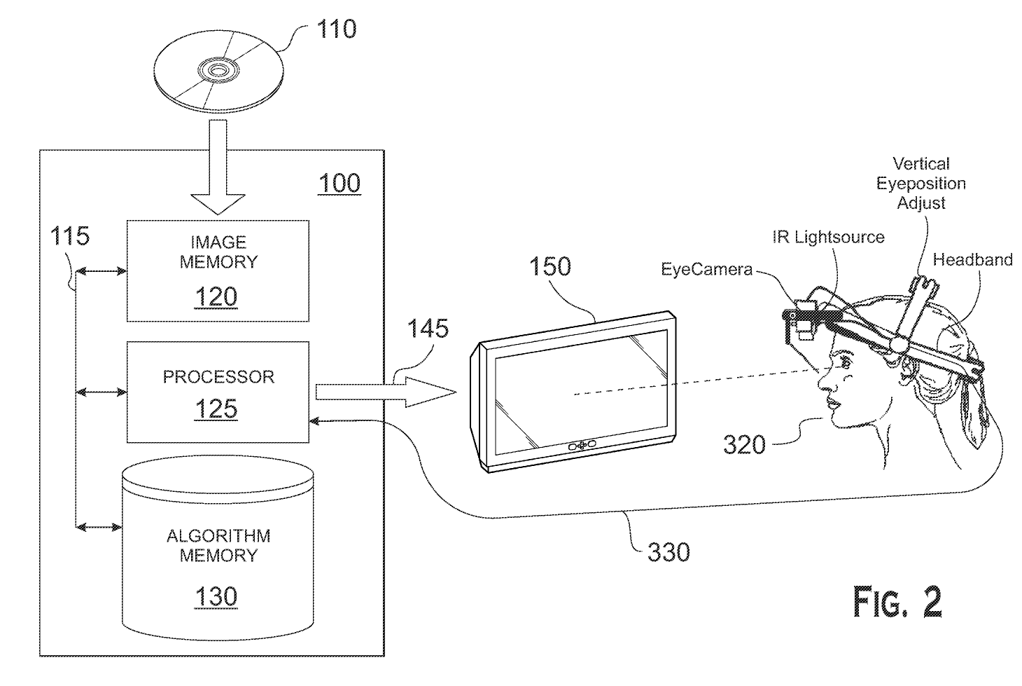

In an embodiment, the area of interest may be determined by determining and tracking an actual viewing direction of a viewer. In this embodiment the area of interest at any moment is an area of the image actually being looked at by a viewer. This embodiment is shown in FIG. 2. FIG. 2 is similar to FIG. 1, with corresponding guide numbers, but with the addition of one type of eye tracking device 310, being worn by viewer 320, and a cable 330 conveying information on the eye position of viewer 320 to processor 125. Techniques for tracking eye position and movements are described, for example, in a document entitled “Eye Controlled Media: Present and Future State” by Theo Engell-Nielsen and Arne John Glenstrup (1995, updated 2006) which may be found at www.diku.dk/˜panic/eyegaze. Techniques for detecting and tracking eye movements include detecting reflected light off of different parts of the eye, measuring electric potential differences of the adjacent skin as the eye moves, and utilizing specially designed contact lenses.

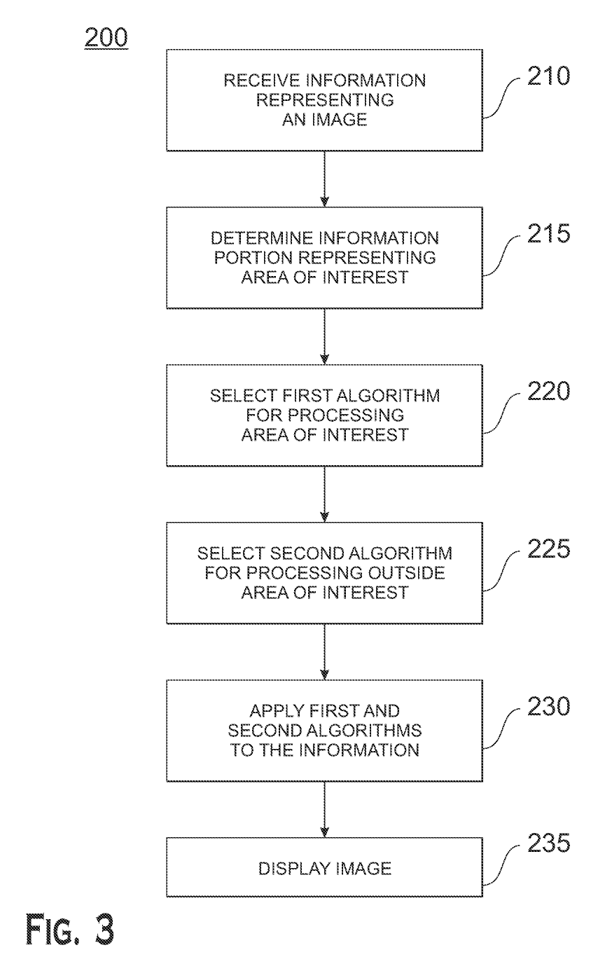

The first and second image processing algorithms applied by processor 125 may be scaling algorithms for increasing or decreasing a size of the image to accommodate display device 150. Each scaling algorithm may be characterized by one or more scaling parameters. Different scaling parameters may be applied to the horizontal dimension of the image and to the vertical dimension of the image independently. The scaling parameter may act as a simple scaling factor, such as reducing the horizontal dimension by ⅔, or the vertical dimension by ½. A vertical scaling parameter may be the same in both the first and second algorithms. A horizontal scaling parameter may be the same in both the first and second algorithms. All horizontal scaling factors and all vertical scaling factors may be the same, in which case aspect ratio is preserved, as described above. Examples of scaling algorithms are pixel dropping and duplication, linear interpolation, anti-aliased resampling, content-adaptive scaling, or application of a scaling filter, some of which are explained in more detail below. The first and second algorithms may include other types of algorithms for processing image information, such as algorithms for processing of video images. Video processing algorithms may include algorithms for color enhancement, color correction, sharpness enhancement, contrast enhancement, brightness enhancement, edge enhancement, motion compensation, compression and decompression, video interlacing and de-interlacing, and scan-rate conversion. All of these types of algorithms may be used in location-dependent image processing, making use of tradeoffs between image quality and speed or required resources. Some of these algorithms are explained in greater detail below in a description of a method shown in FIG. 3.

The particular first and second algorithms selected by processor 125 for processing an image may depend on what image processing resources are available at the time these selections are performed. This is explained in greater detail below in a description of a method shown in FIG. 3.

Processor 125 may include integrated graphics processing circuitry, such as a graphics processing unit (GPU), for processing the image. Alternatively, image processing circuitry, such as a GPU, may be external to processor 125. Image memory 120 may be a volatile memory, such as a conventional random access memory which stores image data during the operation of system 100. Image memory 120 may be a form of Dynamic Random Access Memory (DRAM), for example.

Algorithm memory 130 may be a conventional form of non-volatile memory, such as a hard disk drive for example, which may store image processing algorithms as executable software and retain this software when system 100 is powered down. Algorithm memory 130 may also store other executable software such as operating system software and application software. The operating system software may be executable code representing a conventional operating system such as Windows XP, Linux®, UNIX® or MAC OS™, for example. The application software may be a conventional application, such as a media player or video game, which causes 2D or 3D video images to be generated for display.

FIG. 3 shows an embodiment, not to be construed as limiting, of a method 200 for displaying an image with location-dependent image processing. Information representing an image is received 210. The information may be digital. The information may represent a single still image, or at least a portion of one frame of a moving image. The information may be received from a non-transitory storage medium such as a DVD, CD, tape, or semiconductor memory. The information may be received from a transitory medium such as an electromagnetic carrier wave transmitted over the air or through a coaxial cable or an optical fiber.

The received information representing the image may be stored in a medium such as a volatile memory. The volatile memory may store an entire image or frame and then release the image or frame for processing. Alternatively, only a portion of the image may be stored at any time. Alternatively, the memory may be absent, and information may be processed as it is received, without storage.

A portion of the information representing an area of interest within the image is determined 215. The area of interest may be a fixed, predefined area, such as an area surrounding the center of the image. It may be an area of the image determined to include a moving object. The area of interest may be determined by a portion of the image being looked at by a viewer. In this example, a viewer's viewing direction may be determined and tracked, as described above. Other techniques to identify an area of interest are also possible. These techniques include, for example, techniques to identify objects of interest such as the faces of persons in the image (faces being a typical area of focus for most viewers), or fast moving portions of a video sequence (using, for example, motion vector information), along with others. Some of these techniques will require little or no additional information beyond the image or video stream data.

Returning to FIG. 3, once an area of interest is determined, a first algorithm is selected from a plurality of algorithms, for processing information representing the area of interest 220. A second algorithm is selected from a plurality of algorithms for processing information representing an area of the image not in the area of interest 225.

The first and second algorithms are applied to the processing of their respective portions of the information 230, i.e. the portion of the information representing the area of interest is processed using the first algorithm and a portion of the information representing an area of the image not in the area of interest is processed using the second algorithm. The latter portion may represent the entire image area not included in the area of interest. Alternatively, the area not included in the area of interest may be divided into a plurality of areas, and a separate algorithm may be applied to each portion of information representing each of these areas. The output of the first and second algorithms may then be combined into a single image which is then potentially further processed or ultimately used for display purposes. As will be appreciated, various processing techniques can be used to combine the processed area of interest with the processed area not included in the area of interest. For example, a smoothing or deblocking algorithm can be applied to reduce any perceived differences as a viewer transitions their view from a first area of the final image (e.g., the area of interest processed by the first algorithm) to the second area of the final image (e.g., the area not included in the area of interest and processed by the second algorithm).

The processed information is then used to drive a display device and display the image 235. The information may undergo further processing before it is sent to the imaging device. In an embodiment, the first and second algorithms preserve an aspect ratio of the displayed image. As will be appreciated, these techniques, in some embodiments, may enable a seller of a device embodying aspects of the invention to provide such a device at lower cost (as less costly and less capable components can be used with reduced loss of perceived visual quality by embodying aspects of the invention). The seller may also be enabled to provide such a device having improved perceived quality compared to devices not embodying aspects of the invention (resulting from increased perceived quality on the area of interest). The seller may also be enabled to provide such a device having longer battery life (resulting from lower processing demands in the area not included in the area of interest as compared to processing an entire image by a singular algorithm which requires high performance). The seller may also be enabled to provide such a device having other benefits.

The first and second algorithms may be distinct from one another. They may be selected based on a tradeoff between, on the one hand, image quality and, on the other hand, processing speed or processing resource requirements, such as memory or processor time. As one example, it may be desirable to scale the entire image to increase or decrease the size of the displayed image to fit a particular display. However, applying a single scaling algorithm to all of the information representing the image may be too slow or take up too much processing resources to be feasible. Instead, an algorithm using a relatively large amount of computation or a relatively large amount of computation resources but yielding a relatively high image quality may be applied only to the area of interest, where relatively high image quality is desirable. A relatively faster algorithm using relatively less computation but yielding relatively lower image quality may be applied to image areas outside the area of interest. The end result may then be an image with overall acceptable image quality, achieved with available resources.

In the case of scaling algorithms, for example, a tradeoff between computation resources or speed and image quality may be seen in the sharpness of edges between two areas of different contrast. A relatively simple scaling algorithm, designed to increase the size of an image, may be fast and require relatively little computation, but at the same time will result in jagged edges resembling a staircase. A scaling algorithm using more computation may be slower and require more resources but will result in smoother edges.

A specific example of a pair of scaling algorithms that may be used in method 200 is linear interpolation applied to the area of interest (first algorithm) and pixel dropping and duplication applied to other areas (second algorithm). In linear interpolation, when an output sample of the information of representing the image falls between two input samples, horizontally or vertically, the output sample is computed by linearly interpolating between the two input samples. In pixel dropping and duplication, which may also be referred to as nearest neighbor sampling, a fraction X out of every Y samples are discarded (pixel dropping) or duplicated (pixel duplication) both horizontally and vertically. Pixel dropping and duplication requires fewer computations than linear interpolation but results in edges that are more noticeably jagged (i.e. reduced image quality).

Another example of a pair of scaling algorithms for use in method 200 is an 8-tap scaling filter for the area of interest (first algorithm) and a 2-tap scaling filter for outside the area of interest (second algorithm). “Tap” refers to the number of adjacent samples used in the computation. As the number of taps increases the amount of required computation (required resources) increases but the quality of the resulting image area increases also.

Other known scaling algorithms usable in method 200 include, but are not limited to, anti-aliased resampling, and content adaptive scaling, in which scaling is based in part on the particular image information being scaled, in contrast to a universally applied scaling algorithm.

In addition to image scaling algorithms, the first and second algorithms may include other types of algorithms for processing image information, such as algorithms for processing of video images. Such algorithms may include algorithms for color enhancement, color correction, sharpness enhancement, contrast enhancement, brightness enhancement, edge enhancement, motion compensation, compression and decompression, video interlacing and de-interlacing, and scan-rate conversion. As with scaling algorithms, all of these types of algorithms may be used in location-dependent image processing, making use of tradeoffs between image quality and speed or required resources. The first and second algorithms may be applied (i) during image decoding (also known as decompression) as an image decoding algorithm, (ii) as post-processing activities (i.e., after image decoding), as an image post-processing algorithm, or (iii) as a combination of image decoding and post-processing activities.

The selection of algorithms for processing the area of interest and an area outside the area of interest may depend on computing resources that are available when the selection is performed. In one example, the processing of the information representing an image may be performed on a general purpose computer. The computer may be used for other tasks, such as word processing or Internet browsing, that require their own resources. If these other tasks are running at the same time as image processing is running, the algorithms chosen for processing in the area of interest and not in the area of interest may be algorithms that require relatively fewer resources. Once the other tasks are completed, image processing algorithms requiring relatively more resources and yielding higher quality images may then be used.

In the case of a single image, such as a still image or a single frame of a moving image, the information representing the single image may be stored in a memory. In the case of a frame of a moving image, the memory may be referred to as a frame buffer. Once the single image information is stored, the area of interest may be determined and the first and second algorithms may be applied to the stored information. In the case of a moving image, one frame may be undergoing processing at the same time that a frame that was received and processed earlier is being displayed.

Alternatively, the area of interest may be determined and the algorithms applied to the image information as it is received, without first storing the entire image. This may be referred to as real-time processing. In a moving image, each frame is processed as it is received.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method for processing of an image, comprising:
responsive to the identification of a portion of information representing an area of interest within information representing the image:
selecting a first algorithm to be used for processing the portion of the information representing the area of interest;
selecting a second algorithm to be used for processing a portion of the information representing an image that represents an area of the image not in the area of interest; and
applying the first and second algorithms to their respective portions of the information representing the image.

2. The method of claim 1, further comprising displaying the image following the applying of the first and second algorithms to their respective portions, wherein the applying of the first and second algorithms preserves an aspect ratio of the displayed image.

3. The method of claim 1 further comprising combining into a processed image the processed portion of the information representing the area of interest and the processed portion of the information representing an area of the image not in the area of interest.

4. The method of claim 3 further comprising applying a smoothing algorithm to the processed image.

5. The method of claim 1, wherein the area of interest comprises one or more of: an area surrounding a center of the image, an area determined to include a moving object within the image, an area of the image determined based on a viewing direction of a viewer's eye, or the area of an object of interest within the image.

6. The method of claim 1, further comprising determining and tracking a viewing direction of a viewer's eye, the area of interest being determined from the viewing direction.

7. The method of claim 1, wherein the first and the second algorithms are image scaling algorithms.

8. The method of claim 5, wherein at least one of a vertical scaling parameter or a horizontal scaling parameter is the same in both the first and the second algorithms.

9. The method of claim 1, wherein the selecting of the first algorithm and the selecting of the second algorithm each comprises selecting a video processing algorithm.

10. The method of claim 1 wherein at least one of the first and second algorithms is one of: an image decoding algorithm or an image post-processing algorithm.

11. The method of claim 9, wherein the video processing algorithm is at least one of: a color enhancement algorithm, a color correction algorithm, a sharpness enhancement algorithm, a contrast enhancement algorithm, a brightness enhancement algorithm, an edge enhancement algorithm, a motion compensation algorithm, a compression algorithm, a decompression algorithm, a video interlacing algorithm, a video de-interlacing algorithm, or a scan-rate conversion algorithm.

12. The method of claim 1, wherein the selection of the first and second algorithms depends on computing resources that are available when the selection is performed.

13. A non-transitory computer readable medium storing a program comprising instructions to manipulate a processor to enhance quality of a displayed image, the instructions comprising:
responsive to the identification of a portion of information representing an area of interest within information representing the image:
selecting a first algorithm to be used for processing the portion of the information representing the area of interest;
selecting a second algorithm to be used for processing a portion of the information representing an image that represents an area of the image not in the area of interest; and
applying the first and second algorithms to their respective portions of the information representing the image.

14. The non-transitory computer readable medium of claim 13, wherein the instructions further comprise displaying the image following the applying of the first and second algorithms to their respective portions, wherein the applying of the first and second algorithms preserves an aspect ratio of the displayed image.

15. The non-transitory computer readable medium of claim 13, wherein the instructions further comprise combining into a processed image the processed portion of the information representing the area of interest and the processed portion of the information representing an area of the image not in the area of interest.

16. The non-transitory computer readable medium of claim 15, wherein the instructions further comprise applying a smoothing algorithm to the processed image.

17. A processor configured to perform a method for enhancing quality of a displayed image, the method comprising:
responsive to identification of a portion of information representing an area of interest within information representing the image;
selecting a first algorithm to be used for processing the portion of the information representing the area of interest;
selecting a second algorithm to be used for processing a portion of the information representing an image that represents an area of the image not in the area of interest; and
applying the first and second algorithms to their respective portions of the information representing the image.

18. The processor of claim 17, further configured to preserve an aspect ratio of a displayed image when applying the first and second algorithms.

19. The processor of claim 17, further configured to combine into a processed image the processed portion of the information representing the area of interest and the processed portion of the information representing an area of the image not in the area of interest.

20. The processor of claim 19, further configured to apply a smoothing algorithm to the processed image.

21. The processor of claim 17, further configured to determine the portion of the information representing an area of interest by selecting a predetermined portion of the information representing the image, the predetermined portion representing one or more of: an area surrounding a center of the image, an area determined to include a moving object within the image, an area of the image determined based on a viewing direction of a viewer's eye, or the area of an object of interest within the image.

22. The processor of claim 17, wherein the first and second algorithms are image scaling algorithms.

23. The processor of claim 22, wherein at least one of a vertical scaling parameter or a horizontal scaling parameter is the same in both the first and the second algorithms.

24. The processor of claim 17, wherein the processor is configured to select the first algorithm and select the second algorithm to each be a video processing algorithm.

25. The processor of claim 17, wherein at least one of the first and second algorithms is one of: an image decoding algorithm and an image post-processing algorithm.

26. The processor of claim 24, wherein the video processing algorithm is at least one of: a color enhancement algorithm, a color correction algorithm, a sharpness enhancement algorithm, a contrast enhancement algorithm, a brightness enhancement algorithm, an edge enhancement algorithm, a motion compensation algorithm, a compression algorithm, a decompression algorithm, a video interlacing algorithm, a video de-interlacing algorithm, or a scan-rate conversion algorithm.

27. The processor of claim 17, wherein the processor is configured to select the first and second algorithms depending on computing resources that are available when the selections are performed.

28. The processor of claim 17, further comprising a memory configured to store at least one first algorithm and at least one second algorithm.
